(19) United States
(12) Patent Application Publication
(10) Pub. No.: US 2024/0253458 A1
(43) Pub. Date: Aug. 1, 2024

(54) DETECTING AND VISUALIZING OF A FUEL TYPE USED

(71) Applicant: AUDI AG, Ingolstadt (DE)

(72) Inventors: Bernd MLEKUSCH, Etting (DE); Oliver SCHIELER, Gaimersheim (DE)

(21) Appl. No.: 18/421,632

(22) Filed: Jan. 24, 2024

(30) Foreign Application Priority Data
Jan. 26, 2023 (DE) 102023101879.5

(51) Int. Cl. B60K 15/077; B60K 15/03; B60Q 1/50; F02D 19/06

(52) U.S. Cl. CPC B60K 15/077; B60Q 1/543; F02D 19/0634; B60K 2015/03203; B60K 2015/03217; B60K 2015/03355

(57) ABSTRACT

A method for detecting and visualizing of a fuel type used in a vehicle is disclosed and may include, determining measurement data of the fuel are determined by at least one sensor during at least one of filling of the vehicle with a fuel and operation of the vehicle with the fuel, evaluating measurement data of the fuel by a control unit of the vehicle, and based on the determined measurement data for the fuel activating, deactivating, and/or changing at least one function in any of the vehicle interior and an outer area of the vehicle.

### BACKGROUND

### Technical Field

Embodiments of the invention relate to a method for detecting and visualizing of a fuel type used in a vehicle, as well as a vehicle.

### Description of the Related Art

In the field of vehicles, hybrid vehicles are known which optionally utilize an electric drive or a combustion engine for the propulsion of the vehicle. Such vehicles commonly display to the driver the kind of propulsion utilized.

In the case of vehicles driven solely by a combustion engine, there also exists a potential for environmentally conscious behavior. For example, fuels made synthetically from renewable resources may be used to fuel such vehicles in order to operate the vehicle in a more environmentally friendly manner.

At present, in the known vehicles having a combustion engine, no distinction is made between whether the vehicle is operated with a fuel produced in a standard way from petroleum or with a fuel made from alternative sources, such as one made by means of the Fischer-Tropsch synthesis. In particular, environmentally conscious operators of vehicles having a combustion engine who are willing to pay a higher price for a corresponding fuel, such as an e-fuel, cannot communicate or display this commitment with the vehicles currently available on the market. Hence, environmentally conscious buyers may be reluctant to purchase a high-power vehicle, since even if they fuel this vehicle with 100% renewable fuels the vehicle gives others the impression of being not environmentally friendly.

### BRIEF SUMMARY

The present disclosure provides a method and a vehicle by which a driver may display whether the driver's vehicle is being operated with a fuel made from renewable resources.

The method according to the present disclosure enables the detecting and visualizing of a fuel type used in a vehicle. “Fuel type” may refer to the origin or type of production of the fuel type. For example, the fuel type may be a fuel type produced in common manner from petroleum or a an “XtL” (X-to-Liquid) fuel type.

Measurement data of the fuel may be determined and evaluated by at least one sensor during the filling of the vehicle with a fuel and/or during the operation of the vehicle with the fuel. Based on the measurement data so determined for the fuel type, at least one function may be activated, deactivated, and/or changed in the vehicle interior and/or in an outer area of the vehicle.

According to a further aspect of the present disclosure, a vehicle may be provided which is adapted to carry out the method according to the present disclosure.

The at least one sensor may use an optical measurement process in order to detect features and/or ingredients of the fuel type to be used to ascertain the portion of the fuel made from renewable or environmentally friendly resources. In some embodiments, the data detected by the sensor may assist in ascertaining a chemical composition based on conductivity measurements. In such embodiments, properties of the fuel may be determined, such as the octane number, viscosity, ethanol proportion, density, and the like, and may be assigned to at least one fuel type.

Depending on the type of propulsion or the type of fuel type, one or more features may be activated in the interior of the vehicle or in the outer area of the vehicle, such as displaying the selected type of propulsion or the fuel type being used, or providing a reward when e-fuels or fuel types made from renewable or environmentally friendly resources are used or when the vehicle is electrically operated. Alternatively or additionally, a light signature may be activated on the exterior of the vehicle to show that the vehicle is using the corresponding fuel type or type of propulsion.

In some embodiments, the vehicle owner may actively communicate or signal an environmentally friendly fuel type/propulsion type in the interior and/or on the exterior. As such, environmentally conscious vehicle owners may also drive a high-power vehicle without this being perceived as being negative by others.

In some embodiments, a type of operation of the vehicle utilizing the fuel or a battery electrical type of operation of the vehicle is determined with the aid of the measurement data captured by the at least one sensor. With the aid of the at least one sensor, it is also possible to check whether any fuel is being used in the operation of the vehicle. Such a determination may be made during electrical operation of the vehicle, which may also be determined by way of electric sensors.

In some embodiments, the fuel type may be received from a control unit on the vehicle side when fueling the vehicle or may be determined by measurement data detected by at least one sensor configured as an environment sensor. Information related to the fuel type being used may be obtained during the refueling process. The sensor, configured as an environment sensor, may be, for example, a camera sensor, a LIDAR sensor, a radar sensor, a NFC sensor, a RFID sensor, a communication unit or the like.

In some embodiments, a regular fuel type for a combustion engine of the vehicle, a fuel type with an increased portion from renewable sources, a fuel type produced exclusively from renewable sources, or a type of operation of the vehicle not utilizing the fuel may be determined by evaluation of the measurement data detected by the at least one sensor. Such evaluation of the measurement data, may enable a determination whether a regular fuel, a fuel with increased portion from renewable sources or a 100% renewable fuel is being used or fueled in the operation of the vehicle.

When the fuel type being used originates from an environmentally friendly type of production or a synthetic production by way of renewable sources may be rewarded and/or shown visually.

In some embodiments, at least one function in the form of a visualization is activated in the vehicle interior and/or in the outer area of the vehicle when an exclusively renewable fuel type, a fuel type with an increased portion from renewable sources, or a type of operation of the vehicle not utilizing the fuel is determined. In this way, an environmentally conscious operation of the vehicle may be actively encouraged or promoted by the vehicle. Furthermore, an external effect of the vehicle may be achieved, specifically signaling environmentally friendly operation of the vehicle.

In some embodiments, the function may be activated in the form of a reward for a driver of the vehicle when an exclusively renewable fuel type, a fuel type with an increased portion from renewable sources, or a type of operation of the vehicle not utilizing the fuel is determined. This procedure, in addition to the signal effect, may enable an additional promotion in the form of rewards. For example, the driver may obtain benefits or rewards at local parking garages, access to certain parking places or parking yards, and the like through environmentally friendly operation of the vehicle.

In some embodiments, the function in the form of a reward is activated as a certificate, a credit, a discount, and/or access to an offer. In this way, the fueling of the vehicle with fuel types made from renewable resources may be supported and encouraged.

In some embodiments, the at least one function may be activated and/or deactivated as a light signature, a background lighting, a color of the background lighting of the vehicle interior, a symbol and/or a color in the area of the dashboard, a color of at least one lighting device or means, or at least one lighting device or means in the outer area of the vehicle. Such a function may allow an intuitive visualization and signal effect, emphasizing the environmental friendly or climate-neutral operation of the vehicle.

### BRIEF DESCRIPTION OF THE SEVERAL VIEWS OF THE DRAWINGS

FIG. 1 shows a top view of a vehicle.

FIG. 2 shows a flow chart of a method of detecting and visualizing of a fuel type used.

### DETAILED DESCRIPTION

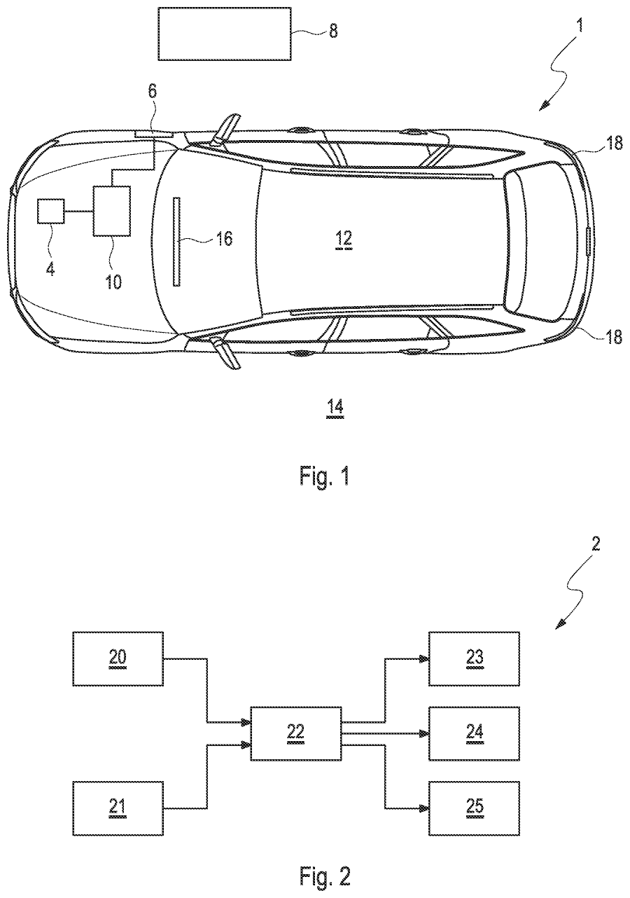

FIG. 1 shows a vehicle 1 in an exemplary embodiment according to the present disclosure. The vehicle may be adapted to carry out a method 2 according to the present disclosure, as illustrated in FIG. 2.

The vehicle 1 in the exemplary embodiment shown includes multiple sensors 4, 6 for gathering measurement data during the operation of the vehicle 1 and during the refueling of the vehicle 1.

Measurement data of the fuel may be detected by a sensor 4 during the filling of the vehicle 1 with a fuel and/or during the operation of the vehicle 1 with the fuel.

The sensor 4 may be an optical sensor or a conductivity sensor and may be coupled to a fuel system (not shown) of the vehicle 1.

The sensor 4 may be arranged on a fueling nozzle or a fuel pump, enabling the sensor 4 to ascertain the properties of the fuel being used.

Furthermore, a second sensor 6 may be provided, which may be an environment sensor or which may act as a communication unit. The sensor 6 may receive data or measurement data from a fueling station 8 during a refueling process such that the sensor 6 may obtain information of the fuel type being used from external sources. For example, labels or designations of the fuel may be detected and evaluated by the sensor 6 being designed as a camera sensor. Alternatively, corresponding data on the fuel being used may be received from a transponder (not shown) of the fueling station 8 or a fueling column of the fueling station 8.

The data received from the sensors 4, 6 and/or the detected measurement data may be received and evaluated by a control unit 10. The control unit 10 may be adapted to identify the fuel type being used based on the evaluation of the data or the measurement data and may activate or deactivate at least one function in the vehicle interior 12 and/or in an outer area 14 of the vehicle 1.

The controller 10 may visually signal, by way of the function, an environmentally friendly type of production of the fuel type being used or a synthetic production of the fuel type by way of renewable resources.

For example, interior lighting 16 may be activated, deactivated, or changed. The interior lighting 16 may be designed in the form of a background lighting, in the form of an indication on at least one display, or the like.

Furthermore, a further function in the form of a light signature 18 may be activated or changed in the outer area 14 of the vehicle 1. For example, in the case of a fuel type having an environmentally friendly type of production, the environmentally friendly operation of the vehicle 1 may be made visible to traffic by activating green or blue lighting elements 18 in the outer area 14 of the vehicle 1.

FIG. 2 illustrates the method 2 according to the present disclosure in an exemplary embodiment. The method 2 serves for the detecting and visualizing of a fuel type used in a vehicle 1, shown, for example, in FIG. 1.

“Fuel type” may refer to the origin or type of production of the fuel type. For example, the fuel type may be a fuel type produced in a typical manner from petroleum or an “XtL” (X-to-Liquid) fuel type.

Measurement data of the fuel may be detected by at least one sensor 4, 6 during the filling 20 of the vehicle 1 with fuel and/or during the operation 21 of the vehicle 1 with the fuel.

The data received or the measurement data ascertained may then be received and evaluated 22 by a control unit 10.

Based on the determined measurement data for the fuel type, at least one function may be activated 23, deactivated 24, and/or changed 25 in the vehicle interior 12 and/or in an outer area 14 of the vehicle 1.

German patent application no. 10 2023 101879.5, filed Jan. 26, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for detecting and visualizing of a fuel type used in a vehicle, comprising:
determining measurement data of the fuel by at least one sensor during at least one of filling of the vehicle with a fuel and operation of the vehicle with the fuel;
evaluating measurement data of the fuel by a control unit of the vehicle; and
based on the determined measurement data for the fuel, activating, deactivating, and/or changing at least one function in any of the vehicle interior and an outer area of the vehicle.

2. The method according to claim 1, further comprising:
determining a type of operation of the vehicle utilizing the fuel or a battery electrical type of operation of the vehicle with the aid of the measurement data of the at least one sensor.

3. The method according to claim 1, further comprising:
receiving a fuel type from a control unit of the vehicle when fueling the vehicle.

4. The method according to claim 1, further comprising:
determining a regular fuel type for a combustion engine of the vehicle, a fuel type with an increased portion from renewable sources, a fuel type produced exclusively from renewable sources, or a type of operation of the vehicle not utilizing a fuel by evaluation of the measurement data of the at least one sensor.

5. The method according to claim 4, wherein the at least one function in the form of a visualization is activated in at least one of the vehicle interior and the outer area of the vehicle when operation of the vehicle is determined to be the type utilizing a fuel type produced exclusively from renewable sources, the type utilizing a fuel type with an increased portion from renewable sources, or the type of operation of the vehicle not utilizing a fuel.

6. The method according to claim 4, wherein the at least one function is activated in the form of a reward for a driver of the vehicle when operation of the vehicle is determined to be the type utilizing a fuel type produced exclusively from renewable sources, the type utilizing a fuel type with an increased portion from renewable sources, or the type of operation of the vehicle not utilizing the fuel.

7. The method according to claim 6, wherein the at least one function in the form of a reward is provided as at least one of a certificate, a credit, a discount, and access to an offer.

8. The method according to claim 1, wherein the at least one function is activated, deactivated, and/or varied as at least one of a light signature, a background lighting of the vehicle interior, a color of the background lighting of the vehicle interior, a symbol in an area of a dashboard of the vehicle, a color in the area of the dashboard of the vehicle, a color of at least one lighting device in the outer area of the vehicle, and the at least one lighting device in the outer area of the vehicle.

9. The method according to claim 1, further comprising:
determining the fuel type based on measurement data of at least one sensor, the at least one sensor configured as an environment sensor.

10. A vehicle which is adapted to carry out a method for detecting and visualizing of a fuel type used in the vehicle, the method comprising:
determining measurement data of the fuel by at least one sensor during at least one of filling of the vehicle with a fuel and during operation of the vehicle with the fuel;
evaluating measurement data of the fuel; and
based on the determined measurement data of the fuel, activating, deactivating, and/or changing at least one function in any of the vehicle interior and an outer area of the vehicle.
